(19) United States
(12) Patent Application Publication
(10) Pub. No.: US 2015/0193900 A1
(43) Pub. Date: Jul. 9, 2015

(54) COMPOSITE DEVICE AND APPLICATION PROCESS AND APPARATUS THEREOF

(71) Applicants: Tak Wai Lau, Kwun Tong (CN); Wing Hong Lam, Kwun Tong (CN)

(72) Inventors: Tak Wai Lau, Kwun Tong (CN); Wing Hong Lam, Kwun Tong (CN)

(21) Appl. No.: 14/409,896

(22) PCT Filed: Jun. 19, 2013
(86) PCT No.: PCT/IB2013/055022

§ 371 Date: Dec. 19, 2014

(30) Foreign Application Priority Data
Jun. 19, 2012 (HK) 12105995.0

(51) Int. Cl. G06T 1/00; G06K 9/62

(52) U.S. Cl. CPC G06T 1/0021; G06K 9/6298; G06T 2201/0052

(57) ABSTRACT

A composite device comprising a human-readable target device and a verification device in machine-readable (or non-human-readable) encoding in which the verification device is related to the target device by a predefined scheme of operation, the target device may comprise a plurality of human readable symbols. For example, the human readable symbols may be arranged into a string of symbols which is also referred to as a ‘token’ herein. The composite device is useful for applications such as authentication, automated Internet access etc.

### FIELD

The present disclosure relates to composite devices, and more particularly to composite devices comprising a human-readable target device and a verification device in machine-readable (or non-human-readable) encoding. The disclosure also relates to apparatus and processes of utilizing composite devices, such as processes and apparatus for verifying authenticity of a target object, for automated network destination access, and/or for verifying accuracy of optical character recognition systems.

### BACKGROUND

The human culture is substantially founded on human readable symbols such as alphanumerical characters, non-alphanumerical characters, Latin or non-Latin characters, Asian characters, Greek, Arabic or Egyptian symbols, in ASCII, Unicode or otherwise, or a combination thereof.

With the growing in social complexity, human readable symbols are often arranged in strings for everyday applications. For example, passport or personal identification information, addresses, names, vehicle registration numbers, and website addresses are in strings of human readable symbols. A string of human readable symbols in this disclosure in interchangeably used with the term “token” where the context permits.

With the increasing sophistication of image process technologies, human readable symbols or strings thereof are often processed by automated means for subsequent utilization. For example, passports are scanned and personal data such as names, date of birth, nationality, passport number are automatically extracted by image processing technologies such as optical character recognition (“OCR”) techniques. The extracted data may be subsequently utilized for various purposes such as statistics, security checking, personal tracking, or immigration control.

While known image processing techniques are very sophisticated, there are rooms for improvement. For example, OCR are not particularly accurate in differentiating similar or highly similar symbols such as between the alphabet “o” and the numeral “0”, between the alphabet “I” and the number “1”, and between the capital alphabet “I” and the lower case alphabet “i”.

It would be beneficial if means are provided to enhance OCR operations on such tokens to make their applications more reliable and/or to expand their scope of applications.

### DESCRIPTION OF FIGURES

The present disclosure will be described by way of examples with reference to the accompanying Figures, in which: —

FIG. 1 shows an example composite device 100,

FIG. 1A is a schematic diagram illustrating an example process to generate a check code from an example target device comprising a string of numerals using an example relation function,

FIG. 2 shows another example composite device 200,

FIG. 2A depicts an example coding and decoding table for the composite device of FIG. 2,

FIG. 3 shows another example of a composite device 300,

FIG. 4 shows another example of a composite device 400,

FIGS. 5 & 5A are schematic diagrams illustrating an example processes to generate a check code from an example target device comprising a string of numerals using other example relation functions,

FIG. 6 shows an example object incorporating an example composite device,

FIG. 6A shows a flowchart for the process of extracting target device, verification device and check code for comparison,

FIG. 7 is an example pixel intensity distribution diagram of an image of the example composite device of FIG. 6,

FIG. 8 is a schematic diagram depicting an example process to perform verification,

FIG. 9 is a schematic diagram depicting the process of enhancing optical character recognition accuracy,

FIG. 10 depicts another example of a composite device 500;

FIG. 11 is a functional block diagram of an example apparatus;

FIGS. 12A and 12B depict the example apparatus of FIG. 11 in operational state;

FIGS. 13A and 13B depict the example apparatus of FIG. 11 in another operational state;

FIGS. 14 and 14A depicts another example of a composite device 700; and

FIGS. 15A and 15B depict an example authentication operation by the apparatus of FIG. 11.

### DESCRIPTION

There is disclosed a composite device comprising a human-readable target device and a verification device in machine-readable (or non-human-readable) encoding in which the verification device is related to the target device by a predefined scheme of operation.

The target device may comprise a plurality of human readable symbols. For example, the human readable symbols may be arranged into a string of symbols which is also referred to as a ‘token’ herein.

The human readable symbols may be alphanumerical characters, non-alphanumerical characters, Latin or non-Latin characters, Asian characters, Greek, Arabic or Egyptian symbols, in ASCII, Unicode or otherwise, or a combination thereof.

The content of the verification device may be different to that of the target device. For example, the verification device may comprise human readable symbols of a different content, patterns, shapes, outlines, a characteristic frequency or characteristic frequency components embedded in a pattern, any other symbols suitable to facilitate machine extraction and verification, and a combination thereof.

The content of the verification device may relate to the target device by a predetermined scheme of operation. The predetermined scheme of operation may be a mathematical or non-mathematical function, a look-up table, or any predetermined relationship.

For example, the verification device may relate to the target device by a hash function to generate a check code such as hash value, a checksum function to generate a check code such as a checksum, and/or a check digit function to generate a check code such as a check digit.

The target token may be arranged into a string of human readable symbols and the encoded verification device is adjacent to or (partly) overlapping with the target token.

The verification device may be encoded in a digital format, and may be encoded to beyond human extraction or recognition.

There is also disclosed an apparatus comprising a processor and an image acquisition device, wherein the apparatus is to acquire an image of a target object, to process the image of the target object to extract a human readable target device by optical recognition and to extract a verification device which is embedded in non-human readable encoding, to verify the target device with respect to the extracted verification device, and to utilize the extracted target device when verification is satisfactory.

The apparatus is to process the target device according to the scheme of operation and to compare result of the scheme of operation with the verification device to facilitate verification.

The apparatus may process the plurality of human readable symbols of the target device to generate a lesser plurality of symbols according to the scheme of operation to facilitate verification by comparison with the verification device.

Where the predetermined scheme of operation is a mathematical or non-mathematical function, a look-up table, or any predetermined relationship, the processor is to process the target device with the function, table or relationship to obtain a result to facilitate verification.

The apparatus may include a user input interface to facilitate user interactive input of data, and the processor is to prompt a user to input data corresponding to the target device or the encoded verification device as shown through a display media such as a built-in display or an external display.

Where the initial verification with respect to an initial image is not satisfactory, the apparatus is to re-view another image of the target object, to process and extract a target device by optical recognition and to extract a verification device by processor decoding from that another image, and to verify a newly extracted target device with respect to a newly extracted verification device.

In an example, the apparatus comprises a telecommunications frontend to facilitate communication with a network and the target device contains address information of a network destination, and the apparatus is to access external network destination utilizing the target device upon successful verification.

In an example, the apparatus comprises an image viewing device for viewing an image of a target object.

In an example, the apparatus is an authentication apparatus and the processor is to verify authenticity of an object with reference to outcome of verification of the target device with respect to the verification device and with reference to a predetermined scheme of operation.

There is disclosed a process of utilizing a composite device disclosed herein, wherein the process comprises processing an image of the target object to extract a human readable target device by optical recognition and to extract a verification device which is embedded in non-human readable encoding, comparing the extracted target device with respect to the extracted verification device, and utilizing the outcome of comparison.

The process may include using the outcome of comparison to determine authenticity of the object.

Where the target device comprises address information of a network destination that is sufficient to facilitate the network apparatus to access said network destination, and the process may include automatically directing a network apparatus to access the network destination upon a satisfactory outcome of comparison. The network apparatus may be a desktop computer, a notebook computer, a tablet computer, a smart phone, or a dedicated network communication apparatus.

The process may include accepting a user interactive input and requesting a user to input the address information upon a failed outcome of comparison.

The process may include using the outcome of comparison to determine accuracy of an optical character recognition process or an optical character recognition apparatus.

The process may include repeating the steps upon a failed outcome of comparison to mitigate user instability during image viewing affecting accuracy.

The process may be in the form of application software for installing onto a computing device, such as a mobile computing device having a built-in image acquisition device and display.

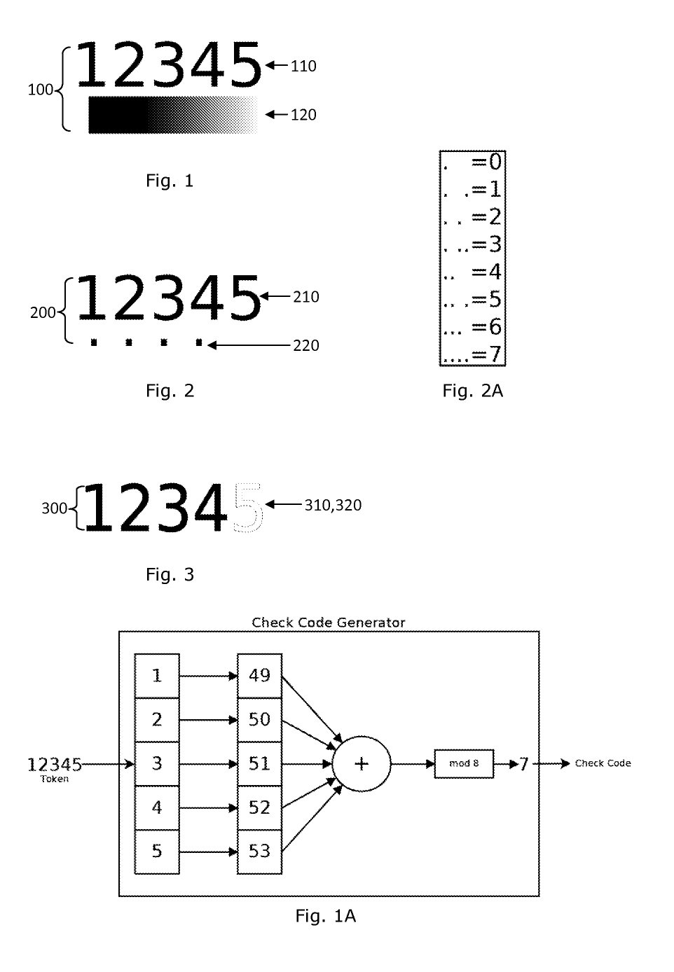

An example composite device 100 depicted in FIG. 1 comprises a target device 110 and an encoded verification device 120 that is neatly placed underneath the target device 110. The encoded verification device 120 is rectangular and has a width and a height that are comparable to that of the target device 110. The target device 110 comprises a string of numerals “12345” which is suitable for use as a target device. The string of numerals as an example of a string of human readable symbols is arbitrarily chosen for convenient illustration. The encoded verification device 120 is in the form of a rectangular block that is parallel to the string of numbers. The encoded verification device 120 is encoded by a machine readable analogue coding scheme using grayscale or intensity coding. As depicted in FIG. 1, the intensity level of the encoded verification device 120 at a position along its length is constant, and its intensity level gradually changes from left to right. More specifically, the intensity level of the encoded verification device gradually changes from a total ‘black’ at the leftmost side to a total ‘white’ at the rightmost side.

The example encoded verification device 120 is an analogue coded representation of the digit ‘7’ which is related to the string “12345” by a function. The function is a check-code generation function in this example. This example check-code function as an example of a predetermined scheme of operation is to generate a check code using the string of numerals of the encoded verification device 120 by assigning an ASCII value to each numeral, summing the assigned ASCII values, and to obtain a modulus-8 value by dividing the sum by 8. The check code obtained will be used to compare with a check value embedded in the encoded verification device to be explained. In this example, the numerals 1, 2, 3, 4, and 5 have respectively the ASCII values 49, 50, 51, 52 and 53 and the total sum of the assigned ASCII values is 255 which gives a modulus-8 value of 7. An example process to generate a check code using this example check code generating function is depicted in FIG. 1A. In another example, the string of numerals is 0, 1, 2, 3, and 4; their ASCII values are respectively 48, 49, 50, 51, and 52; and the total sum of the assigned ASCII values is 250 which gives a modulus-8 check code value of 2.

An example composite device 200 depicted in FIG. 2 comprises a target device 210 and an encoded verification device 220 that is neatly placed underneath the target device 210. The target device 210 comprises a string of numerals “12345” which is identical to that of the target device 110 solely for the sake of convenient illustration. The encoded verification device 210 comprises a string of solid black dots which extends in a longitudinal direction parallel to the length of the target device 210. Each of the solid black dots has a square shape and the dots are of the same dimensions. The string of solid black dots underneath the target device 210 is a digitally coded device in which the first black dot on the left (or the leftmost dot) is used as a reference dot to signify that there is a verification code to follow. The solid black dots to the right of the first solid black dot or the reference dot are coded in a binary format such that a black dot represents “1” and a blank represent “0”. The position which is immediately underneath the first numeral is reserved for the reference dot. If the reserved position under the first numeral on the left is empty or is not occupied by a solid black dot, it means no verification code is included in this encoded verification device 220.

In this example, a modulus-8 check-code function is also used for illustration and a maximum of 3 solid black dots is needed to represent the value of the verification code in the binary format. Therefore, the encoded verification device includes a maximum total of 4 solid black dots, including a leftmost reference dot and a maximum of 3 solid black dots to the right side of the reference dot. Four positions underneath the target device are reserved for the 4 solid black dots and the four reserved positions are at the same separation for convenient identification. A representation showing a correlation between the arrangement of the solid dots and the associated value is depicted in FIG. 2A. The same string of numerals “12345” and the same relationship function are used for convenience. Therefore, the verification code is also a digit “7” which is represented by 3 solid black dots of equal separation from the reference dot.

An example composite device 300 depicted in FIG. 3 comprises a target device 310 and a encoded verification device 320 that is integrated into the target device 310. In this example, the target device 310 comprises a string of numerals “12345” which is identical to that of the target devices 110 & 210 and which is selected solely for the sake of convenient illustration. In this example, the first numeral “1” on the left is used as a reference bit and the numerals to the right of the reference bit are for value coding. A binary coding scheme is used such that a solid black numeral represents a binary bit “1” while an empty or non-filled numeral represents a binary bit “0”. A solid reference bit is used to represent that there are value bits to its right while an empty reference bit means that the target device contains no value coded bits. In this example, the modulus-8 check-code function is also used for illustration and a maximum of 3 numerals is needed to represent the value of the verification code in the binary format. Therefore, the encoded verification device includes a maximum total of 4 numerals, including a leftmost reference bit and a maximum of 3 numerals to the right side of the reference bit. The last numeral “5” is not used in this example but can of course be used if a longer verification code is selected. In this example, the first numeral “1” is in solid black, meaning that there are value coded bits to follow. The next 3 numerals are all in solid black representing a binary value of “111” which is equal to the check code “7”.

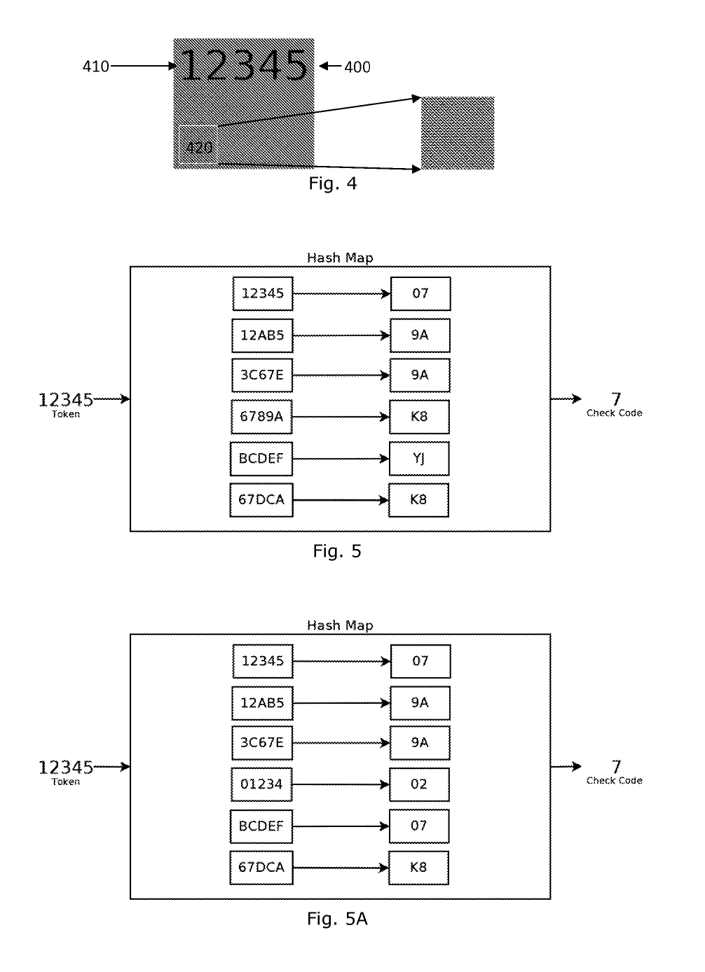

An example composite device 400 depicted in FIG. 4 comprises a target device 410 and an encoded verification device 420 that is integrated into a background to target device 410. In this example, the target device 410 comprises a string of numerals “12345” which is identical to that of the target devices 110, 210, 310 and which is selected solely for the sake of convenient illustration. In this example, the same relationship function is used for convenient illustration and therefore the check code will be the same. This check code is digitally encoded in the form of a digital watermark. In this example, the background is formed by a combination of three digital watermark patterns p1, p2, p3. The three watermark patterns p1, p2, p3 have the same characteristic spatial frequency, for the sake of illustration simplicity, each one of the watermark patterns has its own or characteristic alignment directions and the three characteristic alignment directions are different. The combination of the presence and/or absence of the patterns can be used as a form of digital coding scheme as depicted in Table 1 below, in which a value of “1” means presence of a pattern while “0” means absence.

TABLE 1

| P1 | P2 | P3 | code |
|---|---|---|---|
| 0 | 0 | 0 | 0 |
| 0 | 0 | 1 | 1 |
| 0 | 1 | 0 | 2 |
| 0 | 1 | 1 | 3 |
| 1 | 0 | 0 | 4 |
| 1 | 0 | 1 | 5 |
| 1 | 1 | 0 | 6 |
| 1 | 1 | 1 | 7 |

For example, the check code for the token “12345” according to the relationship function is 7 and this is represented by presence of all the three patterns p1, p2 & p3 in the background. When the check code value is 2, this is represented by presence of p2 and absence of p1 & p3 in the background. When the check code value is 0, none of p1, p2 & p3 is present in the background.

In an example process to determine presence or absence of these patterns, an image of the background is processed by Fast Fourier Transform to obtain frequency domain data and then to extract the characteristic alignment directions to determine the presence or absence of p1, p2, p3.

While alignment directions have been used as the encoding data in this example, the encoding scheme can make use of frequency variation and/or variation of Fourier coefficient magnitude.

Furthermore, watermark techniques such as least significant bit watermarking, discrete cosine transform watermarking, discrete wavelet transform watermarking, Fourier-Mellin transform watermarking, Patchwork watermarking, or a combination thereof, may also be used for producing a machine readable code that carries a check code without loss of generality

Another example relation function to generate a check code from a string of human readable alphanumerical characters of a target device is by way of a hash function as depicted in FIG. 5. In this example hash function, a predefined hash map that defines a mapping between an alphanumeric character string and a two-character check code is shown. For example, the numeric string “12345” is mapped or pre-mapped to a check code “07”, the string of alphabets “BCDEF” is mapped or pre-mapped to the check code “YJ”, and the alphanumeric string “67DCA” is mapped or pre-mapped to the check code “K8”. Another hash map example is depicted in FIG. 5A.

While a check code of alphanumerical characters has been used as an example, it should be appreciated that the check code may not be human readable or may not have a human readable counterpart. For example, the check code may be a specific pattern, such as a pattern having predefined pattern elements distributed in a predefined spacing and/or predefined orientation, a specific shape, or a shape having a characteristic outline to correspond with a specific target device. In another example, the check code may be a pattern having a characteristic spatial frequency or characteristic spatial frequency components to correspond with a specific target device. The correspondence between a target device and a check code may be defined by relations such as by a look-up table.

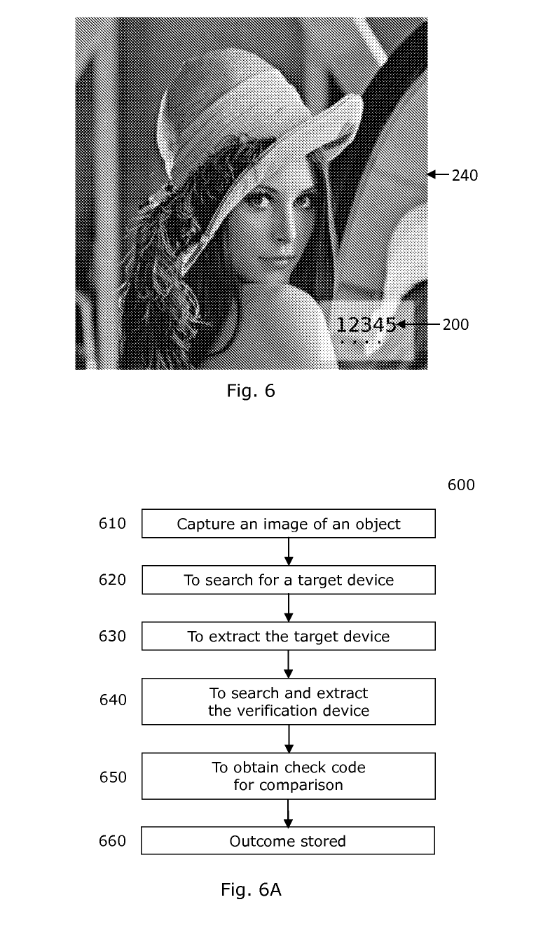

An example process to recover a composite device from an article will be described by way of example with reference to FIG. 6 which shows an example photographic print 240 as an example of an article incorporating an example composite device 200 of FIG. 2 at its lower right corner.

In an example process 600 as depicted in FIG. 6A, an image of the article is captured at step 610 and stored as image pixels in data storage. Image pixels of the captured image are then processed by a processor with an aim to locating and identifying the composite device 200 which comprises a target device 210 in the form of a numeric string. At step 620, the processor will process and analyze the captured image to search for a target device. For example, the processor may use image processing techniques such as optical character recognition (OCR) techniques to locate and identify a string of human readable symbols which corresponds to the target device. The processor may look for a portion of the image which contains outlines of human readable symbols corresponding to the components of the target numerical and then to compare individual outline for example by template matching. At step 630, the processor has found the target numeric string and will extract the numeric string for subsequent application. For example, the extracted numeric string of the target device will be stored as a digital token in a memory for subsequent use. At step 640, the processor will use image processing techniques to search for the encoded verification device. In this example, the processor will use image processing techniques to look for solid black dots having a quadrilateral outline of prescribed dimensions. At step 650, the processor will extract and decode the encoded verification device to obtain a check code for making comparison with a check code derived from the target device using the prescribed relation function. At step 660, the processor will store the outcome of comparison.

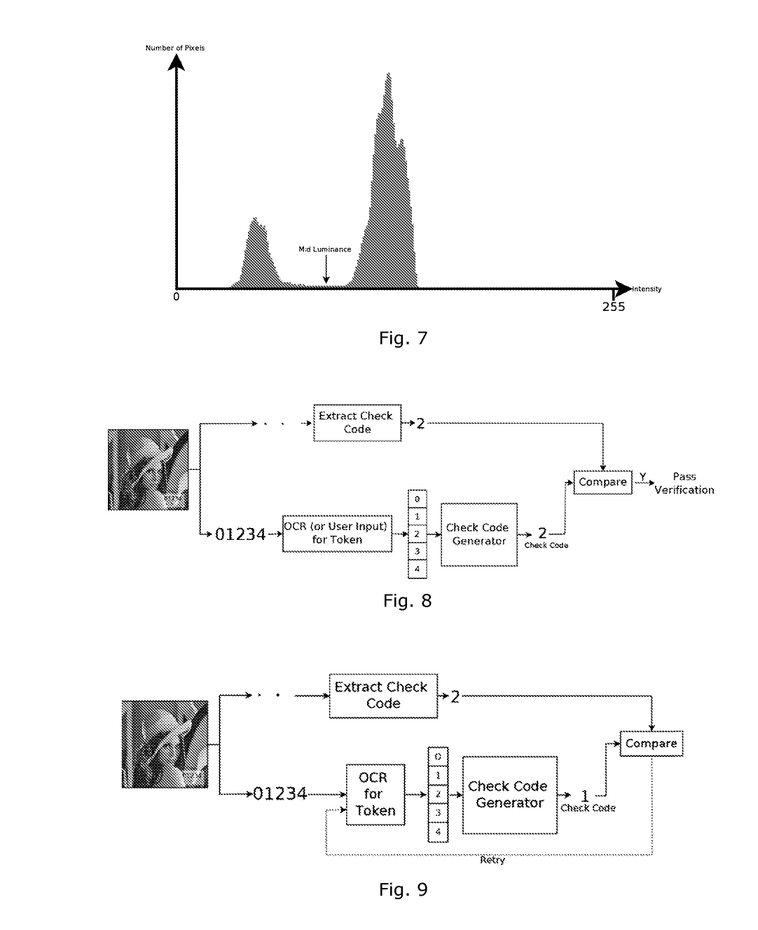

An example technique to extract the encoded verification device of this example from an image of the target object is to utilize characteristic intensity level distributions of pixels forming the image. As depicted in FIG. 7, the pixels can be classified as a high luminance cluster on the right side which is distal from the pixel number axis, a low luminance cluster on the left side which is proximal to the pixel number axis, and a mid-luminance cluster which has a luminance level intermediate the high and low luminance clusters. The low luminance pixels correspond to black or near black pixels while the high luminance pixels correspond to white or near white pixels. To expedite searching for the solid black dots which collectively form the encoded verification device, the processor will search for square shaped dots having the predetermined spacing in the low luminance cluster and to extract the string of solid black dots.

In an example process as depicted in FIG. 8, the composite device may be used as an authentication device for verification of authenticity of an object. As an example, the composite device 210 on the photographic print 240 can be used as an authentication device, although a string of “01234” is used as an example of target device. To verify authenticity of the photographic print 240 as an example of a target article, an image of the photographic print 240 is captured, and the process 600 is performed. At step 650, the check code obtained from the encoded verification device by machine decoding is compared with the check code derived from the target device by the processor. If the outcome of comparison is satisfactory, the photographic print 240 will be classified as genuine. Otherwise, the photographic print 240 will be classified as a fake or counterfeit. For example, where a counterfeit article includes a composite device with a copied target device but does not have an accurate copy of the machine coded verification device, the outcome of comparison or verification would not be satisfactory and the counterfeit article will be identified as such. The verification process as depicted in FIG. 8 may include an optional or additional manual input step to permit a user to input the string of symbols representing the target device 210 to facilitate verification. The processor will then generate a check code from the string of symbols entered and according to the predetermined scheme of operation, and step 650 will be performed again. If the outcome of comparison is satisfactory, the photographic print 240 will be classified as genuine. Otherwise, the photographic print 240 will be classified as a fake or counterfeit.

FIG. 9 depicts a verification process when there is an error in the token extracted by OCR. An image of the machine readable code is captured and decoded, which has a value of “2”. OCR is applied to the captured image of token “01234” to extract the character string. In this example, the numeral “0” is misrecognized as alphabet “O”; hence, the string “O1234” give a check code of “1”. As the check codes from the machine readable code is different to the check code from the token, the verification test has failed and the optical character recognition process is repeated until the recognition succeeds or repeated for a few times before prompting the user to input the token. Hence, the machine readable code is capable of verifying the token extracted by the OCR process; verifying the correctness of the OCR process; and enhancing the accuracy of the OCR process. Suppose that e is the error rate for reading a particular string with an OCR application software. For instance, amongst the set of alphanumeric characters, the numeral “0” is most easily misrecognized as alphabet “O” and the error probability is about 0.5; hence, in the case of FIG. 9, e=0.5. Note that the proposed check code scheme is capable of identifying the error that a numeral “0” is misrecognized as alphabet “O” because the error will give a different check code as described above. Without the check code, the OCR process would have an error probability of 0.5. With the check code the error can be identified and the OCR process may be repeated. With a second round of OCR process, the error probability is e²=0.25. With a third round of OCR process, the error probability is e³=0.125. For the n-th round of OCR process, the error probability is eⁿ. Hence, the error probability can be made arbitrarily small by repetition of the OCR process. Of course, after one round of OCR process, if the OCR process detected an alphabet “O” instead of numeral “0”, the software may attempt to replace the alphabet “O” with numeral “0” and calculate the check code before attempting another round of OCR process.

In another example application, the composite device may be used as a network access device to direct a network apparatus to access a network destination.

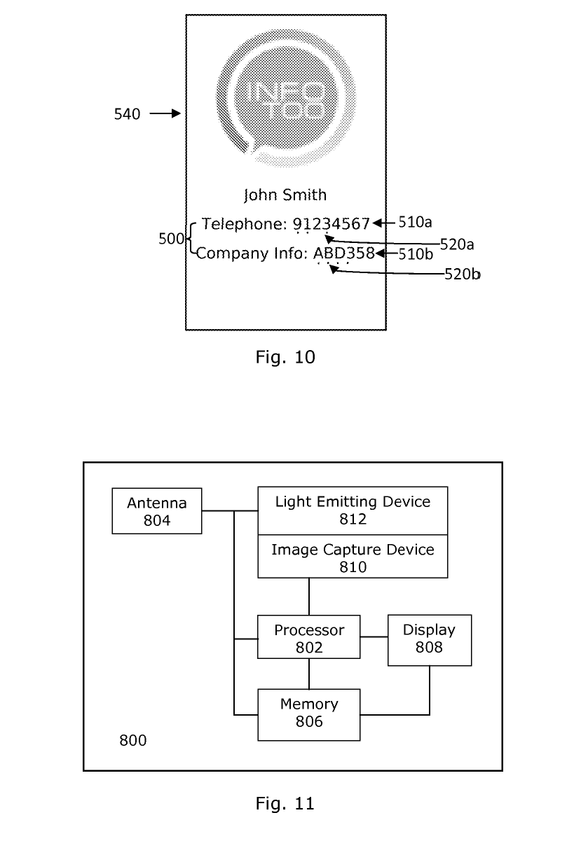

FIG. 10 depicts a business card 540 as an example of an article incorporated with an example composite device 500. The composite device 500 comprises a first target device 510a containing a telephone number, a first encoded verification device 520a to accompany the first target device, a second target device 510b containing company information, and a second encoded verification device 520b to accompany the second target device.

In an example application process, a processor is to capture an image of the business card 540, to process the captured image to extract the components of the composite device 500 for utilization. For example, the processor may extract the first target device 510a, the first encoded verification device 520a, the second target device 510b and the second encoded verification device 520b in a single step. Alternatively, the processor may extract the first group of data comprising the first target device 510a and the first encoded verification device 520a when the first target device is to be utilized, or to extract the second group of data comprising the second target device 510b and the second encoded verification device 520b when the second target device is to be utilized. The first target device after processing by the scheme of operation is to compare with the first encoded verification device and the second target device after processing by the scheme of operation is to compare with the second encoded verification device in the manner described above without loss of generality. Upon successful verification, the first target device may be used to make telephone contact while the second target device may be used to make internet access as examples. In this example, the first target device is a telephone number given by the person, namely “John Smith”, which is unique to the person; hence, the number can be used as an index for the details of the person and customized options, provided that the first encoded verification device is generated and printed on the card as shown. The second target device can be given by a device provider. The second target device is unique and serves as an index to company information and customized options, provided that the second encoded verification device is generated and printed on the card as shown. The device provider may (randomly) generate a pair of target device and encoded verification device for any user. The device provider may do so on a computer server or by having users to install a device generator application on a computing device.

While the example processes have been described with reference to the composite device 200, it should be appreciated that the processes are applicable to other composite devices without loss of generality.

FIG. 11 is a functional block diagram of an apparatus suitable for application use of the composite devices. The apparatus 800 comprises a processor 802, an antenna 804, a memory 806, a display 808, an image acquisition device 810, and a light emitting device 812. A mobile telecommunications apparatus such as a smart phone or a tablet computer is an example of such a device. The application processes herein may be in the form of application software to be installed into the apparatus so as to operate the process by the apparatus as a network access apparatus. The application processes may also be installed on a remote computer server and the apparatus is permitted to remotely access the application. The application software will devise a detection window and a cursor to guide a user to operate the apparatus.

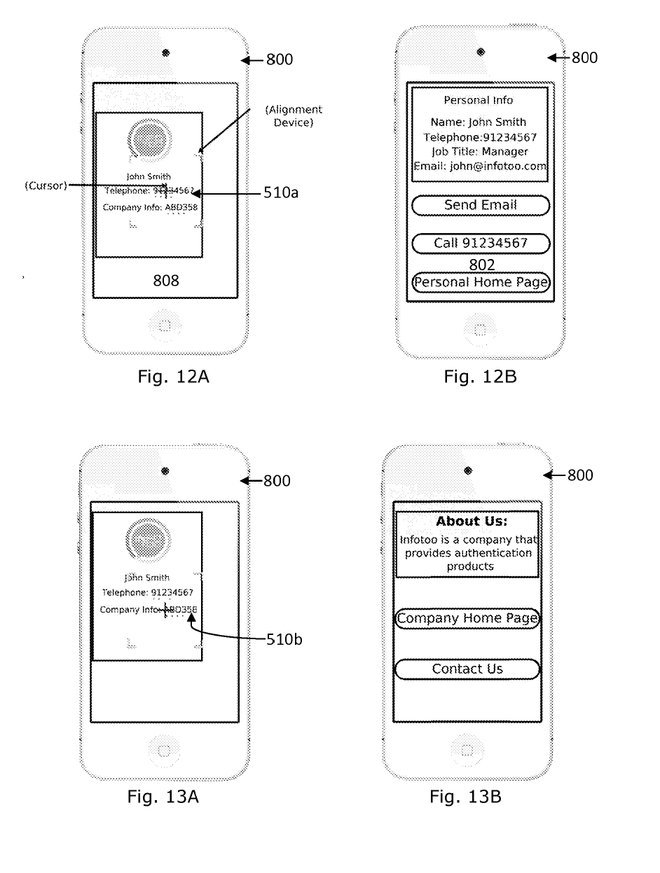

In an example operation of the apparatus as depicted in FIG. 12A, the business card 540 is viewed by the image acquisition device 810 of the apparatus such that an image of the business card will be captured and processed by the processor 802. To indicate an intended use of the first target device 510a, a user will move a cursor on the display into the region of the first group of data. The application software is devised such that moving of the cursor in the region of the first group of data will be interpreted as the user's indication to use the first group of data and vice versa. Upon detecting the cursor in the region of the first group of data, the processor will process and extract the first target device 510a and the first encoded verification device 520a as well as performing the verification process in the same manner as described. Upon successful verification, the processor will operate the apparatus to make telephone contact using the information of the target device, as depicted in FIG. 12B. Furthermore, the processor may also use the target device as an (personal) index to retrieve personal information and customized options such as visiting personal homepage and sending personal email. Likewise, upon detecting the cursor in the region of the second group of data as depicted in FIG. 13A, the processor will process and extract the second target device 510b and the second encoded verification device 520b as well as performing the verification process in the same manner as described. Upon successful verification, the processor will operate the apparatus to make Internet connection, to display customized information, to provide options for visiting homepage and/or contacting the party of interest as examples, as depicted in FIG. 13B using the information of the target device. The user only needs to scan the details to have the options to perform these actions without any manual input. This advantage is realizable because of the enhanced accuracy of the OCR process as provided by the encoded verification device. The presence of the encoded verification device may also perform the function of informing the user that there exists a record of information for viewing and a set of options.

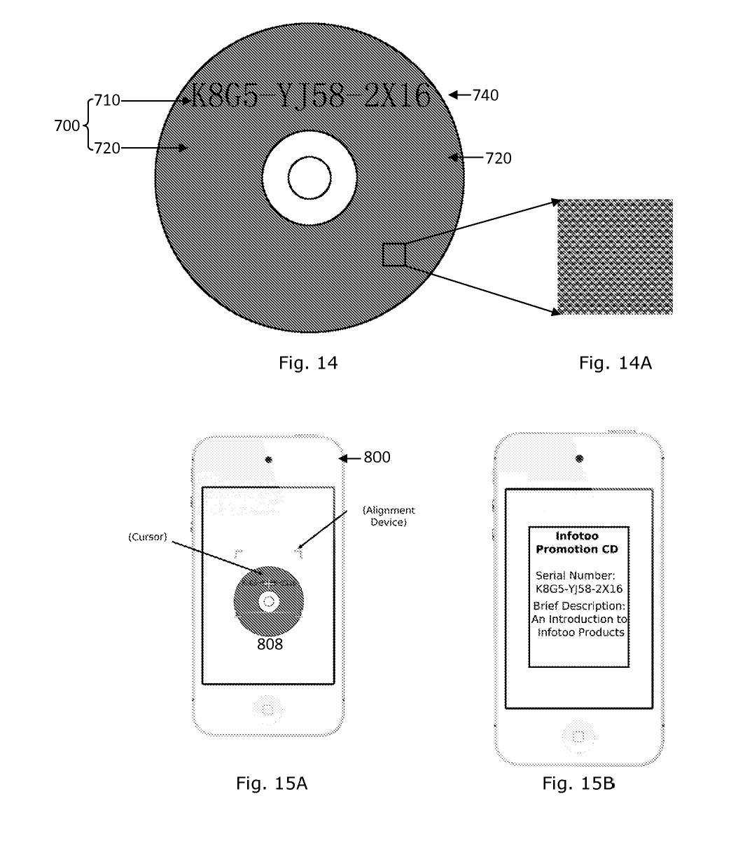

In another example, the apparatus 800 is to operate as an authentication apparatus (or authentication apparatus in short) by having installed an authentication application software, or by accessing the application on a remote computer server. The application software is to device a window and a cursor to be shown on the display 808 to guide a user. In this example, a CD (compact disc) 740 depicted in FIG. 14 is an example article the authenticity of which is to be verified. A composite device 700 is incorporated on one lateral side of the CD 740 and comprises a target device 710 which is a serial number made up of the alphanumeric string “K8G5-YJ58-2X16” on a background of digital watermark pattern which forms an encoded verification device 720. Machine readable codes can be imperceptible to make counterfeiting of the composite device (e.g. serial number+digital watermark) more difficult. Counterfeit items would be identifiable if counterfeiters reproduce the target device (e.g. serial number) without a valid encoded verification device (e.g. digital watermark). Hence, composite devices with imperceptible encoded verification device can enable authentication of items. An enlarged portion of the digital watermark background pattern is depicted in more detail in FIG. 14A. The digital watermark background is encoded by using binary coding of patterns that can be detected in the background pattern by frequency domain transformation as described above.

In use, when the application software is executed, an image of the CD 740 will be captured by the authentication apparatus and shown on the display 808 as depicted in FIG. 15A. A user will then move the cursor to the region occupied by the target device and this activates the verification process as described above. When verification is successful, the authentication apparatus will display product information on the screen as depicted in FIG. 15B.

While various devices, processes, applications and apparatus have been described herein, it should be appreciated that they are examples to facilitate understanding and should not be used to restrict the scope of disclosure. For example, while the encoded verifications devices are illustrated with visible signs or patterns which are machine readable, it should be appreciated that the encoded verification devices need not be visible. For example, the machine readable codes can be invisible codes such as invisible patterns, magnetic data, radio-frequency data or optical data.

1. An apparatus comprising a processor and an image acquisition device, wherein the apparatus is to acquire an image of a target object, to process the image of the target object to extract a human readable target device by optical recognition and to extract a verification device which is embedded in non-human readable encoding, to verify the target device with respect to the extracted verification device, and to utilize the extracted target device when verification is satisfactory.

2. An apparatus according to claim 1, wherein the verification device is different from the target device and relates to the target device by a predetermined scheme of operation, and the apparatus is to process the target device according to the predetermined scheme of operation and to compare result of the scheme of operation with the extracted (decoded) verification device to facilitate verification.

3. An apparatus according to claim 2, wherein the target device comprises a target token which includes a plurality of human readable symbols such as alphanumerical characters, non-alphanumerical characters, Latin or non-Latin characters, Asian characters, Greek, Arabic or Egyptian symbols, in ASCII, Unicode or otherwise, or a combination thereof; the verification device has a lesser plurality of verification symbols and a content which is different to that of the target token; and the apparatus is to process the plurality of human readable symbols of the target device to generate a lesser plurality of symbols according to the scheme of operation to facilitate verification by comparison with the verification device.

4. An apparatus according to claim 3, wherein the target token is arranged into a string of human readable symbols and the encoded verification device is adjacent to or at least partly overlapping with the target token.

5. An apparatus according to claim 1, wherein the verification device is encoded in a digital format, such as a digital watermark, and the processor is to extract the verification device through digital decoding.

6. (canceled)

7. An apparatus according to claim 1, further including a user input interface to facilitate user interactive input of data, and the processor is to prompt a user to input data corresponding to the target device or the encoded verification device as shown through a display media such as a built-in display or an external display; and/or wherein if the verification with respect to the image was not satisfactory, the apparatus is to view and process another image of the target object, to extract a target device by optical recognition and to extract a verification device by processor from that another image, and to verify a newly extracted target device with respect to a newly extracted verification device.

8. (canceled)

9. An apparatus according to claim 1, wherein the apparatus comprises a telecommunications frontend to facilitate communication with a network and the target device contains address information of a network destination, and the apparatus is to access external network destination utilizing the target device upon successful verification; and/or wherein the processor is to verify authenticity of an object with reference to outcome of verification of the target device with reference to the verification device.

10. (canceled)

11. A composite device comprising a human-readable target device and a verification device in machine-readable (or non-human-readable) encoding, wherein the verification device is related to the target device by a predefined scheme of operation.

12. A composite device according to claim 8, wherein the verification device is different from the target device and relates to the target device by a predetermined scheme of operation.

13. A composite device according to claim 9, wherein the target device comprises a target token which includes a plurality of human readable symbols such as alphanumerical characters, non-alphanumerical characters, Latin or non-Latin characters, Asian characters, Greek, Arabic or Egyptian symbols, in ASCII, Unicode or otherwise, or a combination thereof; and the verification device comprises a lesser plurality of symbols and a content which is different to that of the target token.

14. A composite device according to claim 10, wherein the target token is arranged into a string of human readable symbols and the encoded verification device is adjacent to or overlapping with the target token.

15. A composite device according to claim 8, wherein the verification device is encoded in a digital format, including in the form of a digital watermark.

16. A composite device according to claim 8, wherein the verification device is coded to beyond human recognition or beyond human extraction.

17. A composite device according to claim 8, wherein the verification device is related to the target device by a predetermined function such as a hash function to generate a hash value, a checksum function to generate a checksum, and/or a check digit function to generate a check digit.

18. A process of utilizing a composite device according to claim 8, wherein the composite device is on a target object, and the process comprises processing an image of the target object to extract a human readable target device by optical recognition and to extract a verification device which is embedded in non-human readable encoding, verifying the extracted target device with respect to the extracted verification device and the predefined scheme of operation, and utilizing the outcome of verification.

19. A process according to claim 15, wherein the process includes using the outcome of verification to determine authenticity of the target object; and/or wherein the process is in the form of application software for installing onto a computing device, such as a server or a mobile computing device having a built-in image acquisition device and display.

20. A process according to claim 15, wherein the target device comprises address information of a data record in a local or remote database, in which the information is sufficient to facilitate the apparatus to access said data, and the process includes automatically directing the apparatus to access the data upon a satisfactory outcome of comparison.

21. A process according to claim 17, wherein the process includes providing a user interactive input and requesting a user to input the address information upon a failed outcome of comparison.

22. A process according to claim 15, wherein the process includes using the outcome of comparison to determine accuracy of an optical character recognition process or an optical character recognition apparatus.

23. A process according to claim 19, wherein the process includes repeating the steps upon a failed outcome of comparison to mitigate user instability during image viewing affecting accuracy.

24. (canceled)
